(19) United States
(12) Patent Application Publication
(10) Pub. No.: US 2005/0210662 A1
(43) Pub. Date: Sep. 29, 2005

(54) Method of constructing large capacity lithium-polymer power battery and associated cooling system

(76) Inventor: Wenman Li, XinXiang (CN)

Correspondence Address: Kao H. Lu, 686 Lawson Ave., Havertown, PA, 19083, US

(21) Appl. No.: 10/809,305

(22) Filed: Mar. 24, 2004

(51) Int. Cl. B23P 19/00; H01M 6/00

(52) U.S. Cl. 29/730; 29/623.1

(57) ABSTRACT

The present invention relates to a method of making large capacity lithium-polymer power battery array and its associated cooling system. To effectively increase output power, serially or parallel connected multiple individual battery cells with soft shell are used. In order to prevent over heating, metal pipes are imbedded inside the battery between each individual cells and when outside air passes through these pipes, either being forced by fan(s) or flowing naturally, it will effectively reduce the temperature.

### FIELD OF THE INVENTION

The present invention relates to a method of making large capacity lithium-polymer power battery array and its associated cooling system.

### BACKGROUND OF THE INVENTION

The traditional way of packaging a large capacity lithium ion battery is in a form of using a sealed hard case containing chemical liquid within. The traditional packaging have limitation as to certain features, such as explosion prevention, heat reduction and voltage control. Moreover, using polymer structure puts restriction on its capacity. It is needed to have a way of making large capacity Lithium-polymer power battery.

### SUMMARY OF THE INVENTION

This invention overcomes some weaknesses of the traditional single cell lithium ion battery. First, the invention uses a plurality of individual soft shell battery cells, connected in serial or parallel, to form a unit. Then a plurality of such units is combined in serial or parallel to form a final battery, which is placed inside of an outer case made of either metal or plastic. To prevent any battery overheating, arrays of small holes are drilled at the front and back of the outer case, and square or round shaped metal pipes are imbedded in between individual cells; furthermore, a fan coupled with temperature sensor(s) and an protection circuit can be installed inside the battery case. The fan will be automatically turned on once the battery's internal temperature is exceeding a particular range so that it will maintain the battery's internal temperature at acceptable temperature range.

### BRIEF DESCRIPTION OF THE DRAWING

The following is an example of implementation and it will become more apparent by referring to later paragraphs in detailed description section.

FIG. 1 is a diagram of overall combined configuration of the battery;

FIG. 2 depicts a cutaway view of one battery unit;

FIG. 3 depicts a view of one battery unit.

### DETAILED DESCRIPTION OF THE INVENTION

The basic building block of this invention is a soft shell lithium ion battery cell. Many of such cells are connected serially or in parallel to form a battery unit. Then plurality of battery units are further connected in serial or parallel and placed into an outer case made of either metal or plastic to form the final battery. To prevent overheating due to this assembly of battery cells or battery units, arrays of small holes are drilled at the front and back of the outer case and square or round shaped metal pipes are installed in between individual battery cells. Each column of metal pipes can be substituted by a metal plate with a row of hallow holes. In addition, at least one fan can be installed inside the outer case. Furthermore, temperature sensors placed between cells coupled with a control circuit will control the fan. When internal temperature reaches predetermined range, the sensors will trigger the control circuit to turn on the fan(s) so that it will cause the air circulation. The cooler air drawn from outside of the battery will pass through those holes of the outer case and pipes or plates. The air circulation will bring the heat out of the battery. This sensor-fan automatic temperature control system will keep the battery temperature from overheat.

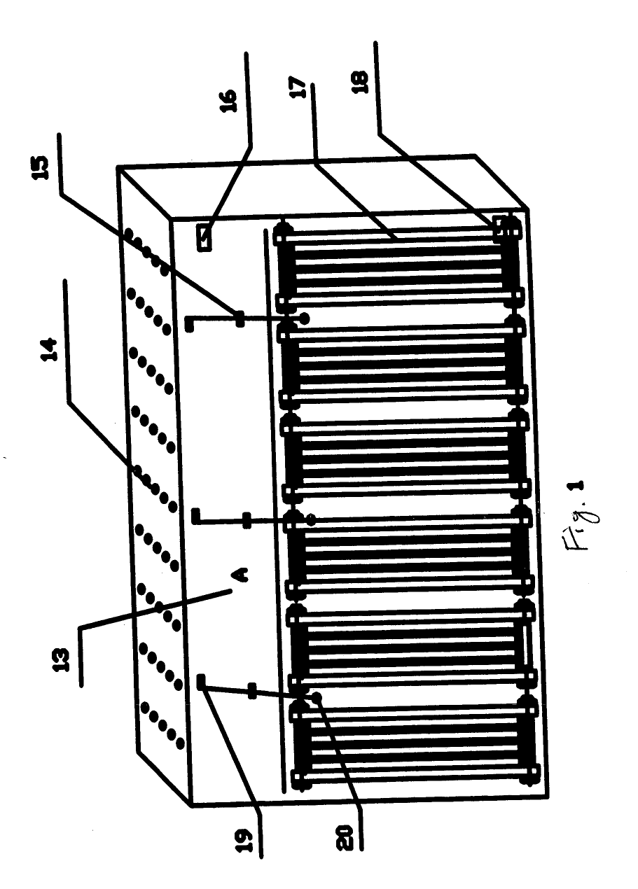

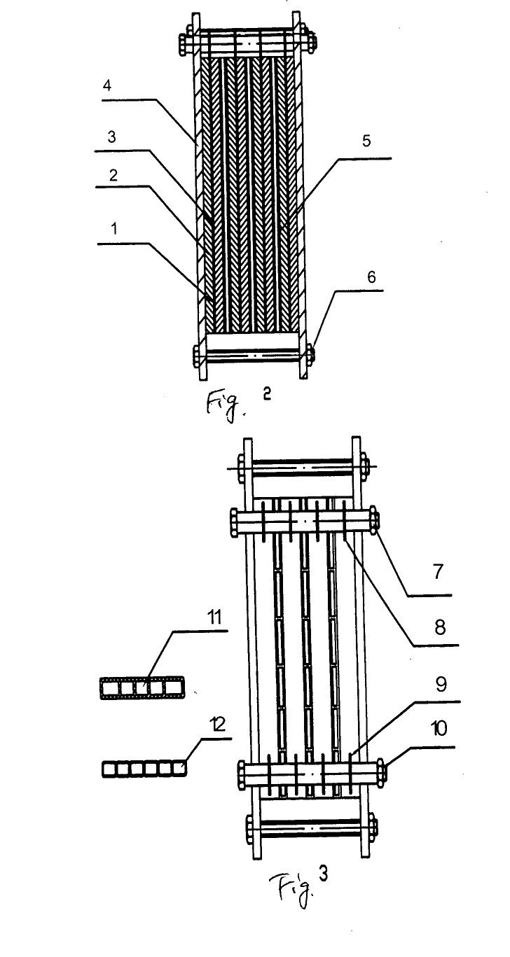

Referring to FIGS. 1, 2 and 3, each individual cell of the battery has a positive plate 2 and a negative plate 3, which are separated by a isolation membrane 1. And multiple cells are combined into a battery unit 17. Then a pair clamping plates 4 with two bolts 6 are used to secure the unit. Next, after multiple battery units 17 are combined, positive leads 8 and negative leads 9 are connected in certain way to form a fixed positive post 7 and a fixed positive post 10 and then both the positive and the negative posts 7,10 pass out through the protection circuit A 13 and eventually connect to the positive terminal 16 and the negative terminal 17 on the outer case respectively, which will be used as contact points for outside connections. In the protection circuit A 13 a temperature controller 15 is connected to a temperature sensor 20 located between battery units. The temperature sensor 20 is monitoring the heat generated inside the battery, converting the temperature reading into signals and passes the signals to the temperature controller 15 of the control circuit 13. When the temperature between the battery units reach or excess a predetermined temperature range, the control circuit 13 will turn on the fan(s). The rotating fan will speed up outside air passing through ventilating inlet/outlet 14 and the cooling plate 11 or the cooling pipe 12. The process will bring inside-battery heat out of the battery very effectively, hence it will prevent the battery from overheat.

When the battery is used on moving vehicles and placed at well-ventilated place, outside cooler air will go through inlets/outlets 14 of the outer case and pass through the cooling plates 11 or cooling pipes 12. If the battery is used under these kinds of settings, the temperature sensor(s) 20, temperature controller 15 and fan(s) 19 can be optional.

Overall, the advantage of the present invention is that the capacity of lithium ion battery can be increased dramatically because its modulated design. The number of battery cells or battery units being used inside a battery case can be flexible. It is easy to replace broken battery cell or unit. Moreover, the holes on the outer case, the cooling pipe/plate and the optional sensor-fan system all will prevent the battery from overheat.

1. A method of constructing large capacity power battery and its associated cooling system, where the battery comprising:
a group of soft shell lithium battery cells connecting in serial or parallel to form a battery unit, a temperature switch controller, at lease one temperature sensor, at least one fan, an outer case with at least one array of round or square ventilation holes drilled on the front of and back of said outer case and hallow metal plates or pipes imbedded between said battery cells; and
a plurality of said units are connected either in serial or parallel into the final battery protected by the outer case, where the temperature sensor is installed between said units; and the fan is installed inside of the outer case that is controlled by said temperature switch controller and the temperature sensor.

2. A method of constructing large capacity power battery and its associated cooling system of claim 1, wherein said soft shell battery cell is regular liquid lithium ion battery, where positive plate is separated from negative plate by a separation membrane, and its shell is made of aluminum coated plastic paper.

3. A method of constructing large capacity power battery and its associated cooling system of claim 1, wherein multiple of said soft shell battery cells connected by positive leads and negative leads are fixed by a pair of clamping plates to make up a unit; multiple said units connected in serial or parallel make up the whole battery which is secured and protected by a metal or plastic case.

4. A method of constructing large capacity power battery and its associated cooling system of claim 1, wherein said metal plates with holes or metal pipes are secured in between said cells by a pair of clamping plates.

5. A method of constructing large capacity power battery and its associated cooling system of claim 1, wherein said ventilation holes are strategically aligned with the positions where said metal pipes or metal plate are located.

6. A method of constructing large capacity power battery and its associated cooling system of claim 1, wherein for stationery application, at least one of said fan is used; and said temperature switch controller is placed in a protection circuit, whereas temperature sensors are imbedded inside or between said units.

7. A method of constructing large capacity power battery and its associated cooling system of claim 1, wherein for moving application, such as mounted on moving vehicle, there will be no need for said fan, said temperature switch controller and temperature sensors to be installed.
